(19) United States
(12) Patent Application Publication
(10) Pub. No.: US 2017/0004722 A1
(43) Pub. Date: Jan. 5, 2017

(54) Systems and Methods For Facilitating Peer-To-Peer On-Line Tutoring

(71) Applicant: Stacy L. Dragos, Peoria, AZ (US)

(72) Inventor: Stacy L. Dragos, Peoria, AZ (US)

(21) Appl. No.: 14/789,764

(22) Filed: Jul. 1, 2015

(51) Int. Cl. G09B 7/02; G09B 7/06

(52) U.S. Cl. CPC G09B 7/02; G09B 7/06

(57) ABSTRACT

Systems and methods are provided for pairing a first student seeking academic assistance with a second student qualified to provide the assistance. The system is configured to receive, from the first student, a first survey including information pertaining to the subject matter for which tutoring is sought, the grade level, school name, teacher name, and a first schedule of availability. The system also receives, from a second student, a second survey including information pertaining to the subject matter in which the second student is proficient and a second schedule of availability. The system compares the first and second surveys to determine a match, and facilitates an initial communication level between the first student and the second student while preserving the anonymity of the first student.

### TECHNICAL FIELD

The present invention generally relates to systems and methods for facilitating interactive tutoring. More particularly, the following discussion relates to an on-line platform for matching students having a need for tutoring with students qualified to provide tutoring, and for facilitating on-line tutoring between the tutor and tutee while selectively preserving the tutee's anonymity.

### BACKGROUND

Primary schools, secondary schools, and colleges struggle to provide quality education in the face of competing economic, political, and social pressures. Many western cultures including the United States experience high levels of attrition resulting from students' reluctance to ask for help in the classroom to avoid being perceived as lacking intelligence. Many of these students seek tutoring from sources outside the classroom. Presently known tutoring programs such as those embodied in products available from Mathnasium™ (www.mathnasium.com), Pearson′ (www.pearsoned.com), and Kumon™ (www.kumon.com), however, tend to use an “outside in” paradigm in which pre-configured content is presented to the student. This approach is limited in its ability to target a particular tutee's unique questions and concerns.

Presently known tutoring programs are also disadvantageous in that they tend to pair a younger tutee with an older tutor who has little or no knowledge of the tutee's school, teacher, classroom environment, or school culture. Consequently, the tutor and tutee may have little in common, which can impede effective learning.

In addition, presently known tutoring paradigms typically require a student to travel to a tutoring facility for face-to-face (in person) interaction, which many students find uncomfortable due to the social stigma associated with being perceived as less intelligent than academically superior students.

Other known tutoring are very informal, and involver a teacher or counselor suggesting tutor/tutee parings among students. This approach can be embarrassing, however, to the extent that the tutee's identity is disclosed to the prospective tutor before the tutee agrees to the arrangement.

Various social networking platforms such as Facebook™, Yahoo™, and Linkedin™ allow users to request and obtain assistance with homework assignments, problem solving, and the like. However, these social enclaves do not support the type of focused, one-on-one tutoring needed by many struggling students.

Systems and methods are thus needed which overcome these limitations. Various desirable features and characteristics will also become apparent from the subsequent detailed description and the appended claims, taken in conjunction with the accompanying drawings and this background section.

### BRIEF SUMMARY

The present invention relates to systems and methods for matching a tutor with a tutee by approximating the degree of success that a user of the tutoring service will have in a tutoring relationship with various candidate tutors, and matching the tutee with an appropriate tutor based on the approximated degree of success.

Various embodiments of the present invention relate to systems, methods, and on-line platforms for: i) pre-qualifying a pool of tutors; ii) evaluating prospective tutors against tutee-specified criteria to identify tutor/tutee pairs that are likely to have a positive peer tutoring experience; iii) recommending a subset of selected tutors to a particular tutee based on empirical data; iv) selecting one of the recommended tutors by the tutee; v) gradually introducing the selected tutor to the tutee while selectively preserving the tutee's anonymity; and vi) facilitating “inside-out” tutoring sessions tailored to the individual tutee and directed to that tutee's specific educational needs in a socially safe, on-line environment.

One aspect of the present invention provides a tutoring paradigm which addresses both the educational and social components involved in a tutor/tutee relationship. In particular, prospective tutors and tutees are carefully screened based on predetermined criteria to ensure that the educational requirements are satisfied; that is, the tutor is familiar with the tutee's school, teacher, and/or subject matter. In addition, by initially introducing the tutee and tutor anonymously, the tutee may wade into the relationship unencumbered by the fear of being exposed as less intelligent. As the relationship progresses, the interaction may proceed from text and white board, to audio chat and ultimately video chat. In this way, the tutee's identity is only revealed to the tutor once a certain level of social comfort and interpersonal trust is established.

In various embodiments, tutors may be pre-qualified based on a number of criteria, such as having mastered the subject matter for which tutoring is sought, or being part of an honors or academic society which encourages community service such as peer tutoring. Other embodiments employ tutee-specified criteria in selecting candidate tutors, such as recent experience with a particular academic subject at a particular school or with a particular teacher.

When a tutee desires to communicate with a selected tutor, the peer tutoring service facilitates communication in a plurality of formats. For example, the students may exchange information by providing answers to open ended questions or exchanging items selected from a list, with the questions either proposed by the service or suggested by the parties.

The peer tutoring service also facilitates advancing through a hierarchy of communication levels, which may be sequenced to ensure a gradual introduction of the parties to each other. In addition, the subject matter of the communications may be controlled to delay the exchange of more personal information to later levels after trust has been established. In one embodiment, the service controls when the parties advance from a lower communication level to a higher level. Alternatively, the parties may select when they will advance from one communication level to the next.

The peer tutoring service can facilitate the exchange of information by receiving apportion of a communication from one party, and forwarding it to the other party. The matching service can also modify the communication as needed to conceal the identity of the sending party.

In various embodiments, the identification and selection of candidates for a tutor/tutee relationship is based on empirical data about the parties, and a success estimator to approximate the success a user is likely to have with other users. Candidates are matched based on the results. In this way, potentially conflicting tutoring relationships may be avoided.

In accordance with a further aspect of the invention, potential tutors are often highly motivated to engage with tutees, in part because many honors programs and societies impose a community service requirement which a tutor can fulfill through peer-to-peer tutoring. In addition, successful tutoring can enhance the tutor's resume when seeking employment and college admission.

Various other embodiments, aspects and features are described in more detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a schematic block diagram of an exemplary system for interconnecting tutees and tutors on a web platform including a cloud-based facilitator in accordance with various embodiments;

FIG. 2 is a schematic block diagram illustrating, conceptually, a process by which a tutee is paired with a tutor in accordance with various embodiments;

FIG. 3 illustrates an example of a survey that is answered by students in accordance with various embodiments;

FIG. 4 illustrates the structure and contents of an empirical database generated from the answers to the survey illustrated in FIG. 3 in accordance with various embodiments;

FIG. 5 is an example of a correlation matrix that shows the degrees of correlation between entries in the empirical database in accordance with various embodiments;

FIG. 6 illustrates the structure and contents of a factor value database that lists the value of the factors for particular students in accordance with various embodiments;

FIG. 7 is a flow diagram illustrating an exemplary method of operating a matching service in accordance with various embodiments;

FIG. 8 is a flow diagram illustrating an exemplary method of preparing empirical data in preparation for matching a tutee with one or more tutor candidates in accordance with various embodiments;

FIG. 9 is a flow diagram illustrating an exemplary method for using the prepared empirical data to match a tutee of the matching service with one or more tutors in accordance with various embodiments; and

FIG. 10 is a flow diagram illustrating an exemplary method of providing communication between the user of the service and the one or more candidates in accordance with various embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Various embodiments of the present invention relate to strategically (e.g., algorithmically) connecting tutors and tutees in an online, cloud-based tutoring platform to facilitate focused, one-to-one direct tutoring while allowing the tutee to determine when his or her identity is revealed.

In an embodiment, a high school, charter school, or other institution may register with a web site or web portal to join the peer-to-peer tutoring service. Students desiring to be tutors may receive in-person or on-line training on how to effectively tutor, as well as social “do's and don'ts” (e.g., etiquette, privacy). The method includes decision points at which the tutor and tutee agree to advance to the next level, for example, from an anonymous white board and chat environment to an environment in which identities may be revealed such as audio and/or video chat.

The school then invites families (e.g., via email) to use the tutoring service, and provides a link to the tutoring site. To sign up a putative tutee, a parent or guardian logs on and initially registers the student, then the parent or prospective tutee fills out a questionnaire. The questionnaire may be in the form of one or a series of drop down menus used to create a profile for the tutee. The tutee profile may be used to identify a pool of tutor candidates, which may then be presented to tutee for selection.

If every student desiring assistance and every student willing to assist had to independently coordinate with an in person coordinator, such as a high school guidance counselor, the pairing process would quickly become prohibitively cumbersome, as well as potentially embarrassing for the tutee. But by logging onto a platform, the tutee's anonymity may be preserved until the tutee is comfortable revealing his or her identity. This automated pairing process is also more objective, using predetermined criteria to drive the selection process.

In an embodiment, the tutee profile includes information pertaining to one or more of the following metrics: the grade level, class, subject, teacher, knowledge level, male/female, age, other outside activities and interests, and the like. Automating the selection process also makes it feasible to conduct time-sensitive pairing (e.g., “I need help tonight”) for a large student population. In this regard, it is desirable to specifically identify the particular teacher for which tutoring is sought, inasmuch as a student can sometime be marked down for a correct answer if a problem is not solved in the manner prescribed by that teacher.

Once a prospective tutee creates a profile, the profile is evaluated against a pool of prospective tutors using various protocols, techniques, and/or algorithms described in greater detail below. In various embodiments, evaluating a tutee against prospective tutors may involve techniques described in Buckwalter et al. U.S. Pat. No. 6,735,568 B1, the entire contents of which are hereby incorporated herein by this reference. The evaluation process identifies one or more candidate tutors, which are then presented to the tutee for selection. In a preferred embodiment, the tutors and tutees use usernames, pseudonyms, or other unique handles which preserve anonymity. In this way, students are encouraged to seek help without disclosing their true identity until they choose to do so.

In an embodiment, the candidate tutors may be ranked or otherwise rated, much like Ebay™ buyers and sellers are rated based on previous interactions with others. In this regard, tutors are motivated to earn favorable ratings from tutees, to the extent higher ratings may translate to improved employment and/or college admission opportunities.

Once a tutee selects a desired tutor, the tutor may be given the opportunity to agree to be paired with this tutee for particular subject matter and for a proposed schedule. A partner relationship is then established, even though their identities are not yet known to each other. A mutually agreeable schedule (typically 30 minutes sessions per subject) is then set up, for example, two peer-to-peer sessions per week for several months. Reminders may be sent to both parties via text, email, or the like.

The screening process should preferably define the subject matter for which tutoring is sought in reasonable detail for at least the first meeting. Thereafter, the subject matter can be defined at the end of each session for the next session. Specific documents, problems, or assignments can be uploaded by the tutee so the tutor can review them in advance of a tutoring session. The tutor and/or tutee can create a record summarizing each session, and the data preserved for later harvesting, quality control, and process refinement and improvement.

The present inventor has determined that a student is more likely to learn if the student initiates the tutoring. As such, taking the time to go through the registration, profile building, and selection process gives the tutee a sense of ownership in his or her education, thereby increasing educational achievement.

In another embodiment, a “Help me now” option subordinates the other criteria (e.g., prior experience with the same teacher) to the higher objective of immediate availability. In addition, at least one tutor may be always “on call,” regardless of the degree of correlation between the tutee profile and the tutor, to facilitate tutoring on an expedited basis. Moreover, a “panic” virtual button may be invoked when the tutor and tutee get stuck and need to invite an on call teacher or expert into a peer-to-peer session.

Various aspects of the invention relate to the functions and operation of a matching (or pairing) module for selectively pairing a tutor with a tutee. The matching module employs empirical data to identify and select one or more tutor candidates for a tutoring relationship with a user (tutee) of the tutoring service. When the tutee and one of the selected tutor candidates wish to communicate, the matching service allows them to communicate at a plurality of communication levels. Each of the communication levels may also permit the parties to exchange information in a different format. Examples of exchanging information at different communication levels include exchanging answers to open-ended questions provided by the matching service, exchanging items selected from a list provided by the matching service, exchanging answers to open-ended questions provided by the matching service and exchanging questions and answers written by the user and/or the candidate.

In one embodiment of the invention there is no sequence assigned to the communication levels and the parties agree to the communication level at which they will communicate. As a result, a tutee who may be uncomfortable disclosing his or her identity in a very open format can choose to communicate—at least initially—using a more closed format such as one for exchanging closed-ended-questions.

In another embodiment, the matching service requires that the parties advance through a particular sequence or hierarchy of communication levels. The matching service can sequence the communication levels to ensure a slow introduction of the tutee to a prospective tutor. Additionally, the subject matter of the communications can be controlled to limit the exchange of more personal information to later communication levels. The service starts the parties, namely, the tutee and the candidate tutor, communicating at a particular communication level. In one embodiment, the matching service controls when the parties advance from one communication level to another. In another embodiment, the parties are able to select when they will advance from one communication level to the next level. This approach is generally analogous to the manner in which dating services slowly introduce people into romantic relationships (e.g., www.eharmony.com).

The matching service can facilitate each exchange of information by receiving a portion of the communication from one party and then forwarding the communication to the other party. The matching service can modify the communication so the identity of the sending party is concealed. As a result, the communication between the parties can remain anonymous, if desired.

The identification and selection of tutor candidates for a particular tutee is based on empirical data about students and the satisfaction they are likely to have in a tutoring relationship. The matching service prepares the empirical data for use in matching a tutee to one or more prospective tutors. The data preparation can include generation of an individual satisfaction estimator and a tutor/tutee (also referred to herein as a “pair”) satisfaction estimator.

The individual satisfaction estimator and a pair satisfaction estimator are used to match a tutee to one or more prospective tutors selected from a pool of candidate tutors. A user of the matching service (typically a tutee seeking a tutor) completes a survey to provide data to the matching service. The user's data is compared to an individual satisfaction estimator to approximate the satisfaction the user has in his/her relationships with others. Tutor candidates for matching with the tutee are identified based on the results. For instance, the candidates have results which are similar to the tutee to reduce matches between people who are likely to have conflicting relationships.

One of the identified tutor candidates is then selected by the tutee. Data for the tutee and data for the selected tutor are compared to approximate the satisfaction that the tutee is likely to have in a tutoring relationship with the selected tutor. This can be repeated for one or more of the identified candidates. The results are studied to identify the candidate and user combinations that would result in the most satisfactory pairing. The tutee and one or more of the identified tutor candidates are then given the option of communicating with one another.

As described above, the approximate individual satisfaction index and the pair satisfaction index are generated from empirical data. The empirical data is generated from surveys completed by the tutees and tutors. Each survey includes a plurality of inquiries into matters which are relevant to each individual in forming a tutoring relationship. The inquiries can have numerical answers. These answers are used in a factor analysis to identify factors that are each a function of one or more correlated inquiries. These factors are used in the generation of the individual satisfaction estimator and the pair satisfaction estimator. Because the factors are a function of several inquiries, the use of the factors reduces the number of variables considered when generating the approximate individual satisfaction index and the pair satisfaction index. However, the complexity of the relationships between the variables (question answers) is retained in the results because each of the variables are taken into consideration when generating the factors.

In one embodiment of the invention, a matching service or matching module may employ the methods disclosed in this specification to train a neural network. Training the neural network allows the matching service to take advantage of a neural network's ability to resolve problems in the presence of noisy and complex data. Additionally, the matching service can take advantage of the neural network to learn to improve the quality of the matching results.

FIG. 1 illustrates an embodiment of a peer-to-peer tutoring system 100 for matching a student needing academic assistance with a student equipped to provide the assistance. The system 100 includes a network 112 configured to facilitate communication between a matching service 114 and one or more remote computers 116, such as a tutor computer 116(a) and a tutee computer 116(b). The matching service 114 can include one or more processing units for communicating with the remote computers 116. The processing units may include electronics for performing the methods and functions described herein. In one embodiment, the processing units include a neural network. Suitable remote computers 116 include, but are not limited to, desktop personal computer, workstation, telephone, cellular telephone 116(c) connected to the network 112 via a cell tower 117 or other wireless link, personal digital assistant (PDA), laptop, or any other device capable of interfacing with a communications network. Suitable networks 112 for communication between the server and the remote computers 116 include, but are not limited to, the Internet, an intranet, an extranet, a virtual private network (VPN) and non-TCP/IP based networks 112.

Examples of communications between a computer 116 and the matching service 114 include exchange of electronic mail, web pages and answers to inquiries on web pages. The matching service provides the communication by receiving the communication from one user and providing the communication to another user. The matching service 114 can modify the communication from one user to another user. For instance, the matching service 114 can change the user's real name on an e-mail to a username so the sending party's identity is protected. The username can be assigned by the matching service 114 when the user signs up for the service or can be selected by the user when the user signs up for the tutoring service.

A first user can also communicate directly with another user without having to go through the matching service portal. This direct communication can occur after the users exchange e-mail addresses or phone numbers during a communication through the matching service 114. Alternatively, one user can request that the matching service 114 provide another user with his/her direct communication information, i.e., e-mail address.

In an embodiment, the matching service implemented by the matching module 114 employs a data preparation stage, a matching stage, and a communications stage. During the data preparation stage, empirical data is manipulated in preparation for the matching stage. The empirical data is used to match one or more candidate tutors with a tutee in the matching stage. At the communication stage, communication is achieved between the tutee and one or more of the prospective tutors. The communication can occur in one or more communication stages which are agreed to between the tutee and the selected tutor.

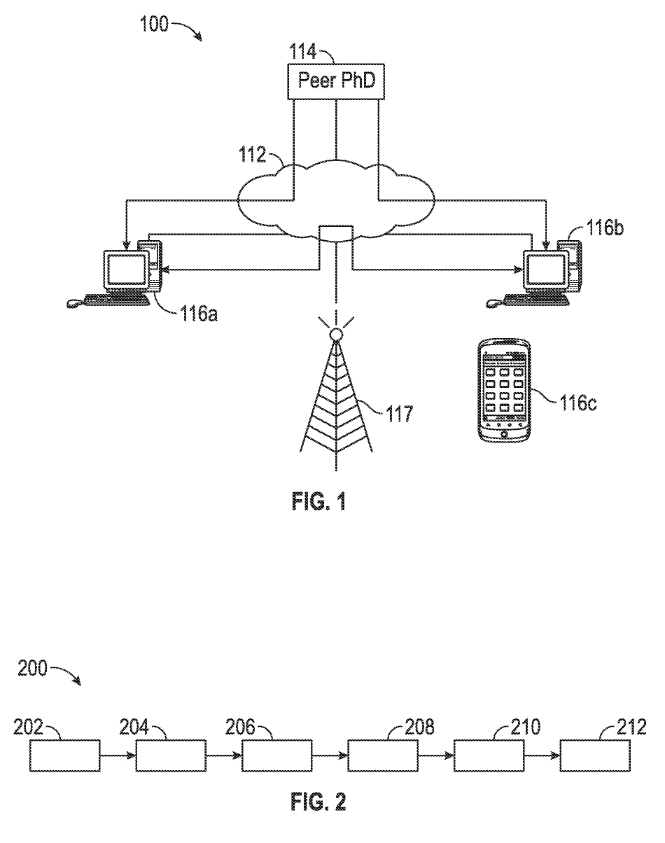

Referring now to FIG. 2, a schematic block diagram illustrates, conceptually, a process 200 by which a tutee is paired with a tutor. More particularly, survey data 202, which may include a tutee profile, is applied to a matching module 204, whereupon a list 206 of candidate tutees is generated. The tutee selects a particular candidate tutor 208, and the selected candidate tutor 208 may be given the opportunity to accept or decline the tutoring engagement at stage 210. If the selected tutee 208 accepts the tutee, a pairing 212 is formed therebetween. In an embodiment, the process outlined in FIG. 2 may employ usernames to preserve the anonymity of at least the tutee. Alternatively, the actual identities of the parties may be disclosed.

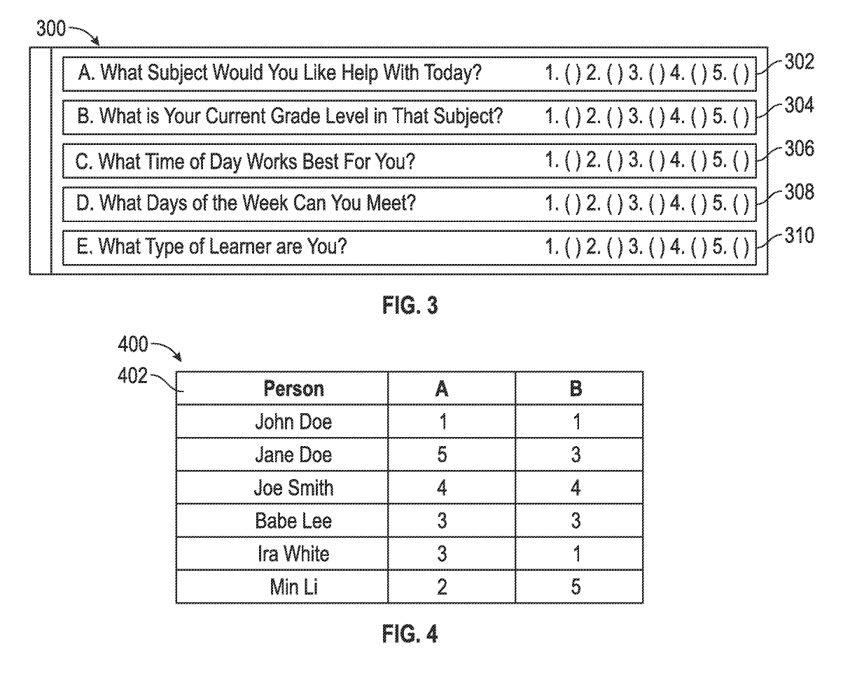

Referring now to FIGS. 1-3, the matching service 114 suitably employs empirical data during the data preparation stage. The empirical data may be generated from answers to surveys such as the survey 300 illustrated in FIG. 3. The survey 300 may be configured to ask a series of inquiries 302-310, the answers to which may be specified by the system (closed ended) or defined by the person filling out the questionnaire (open ended). For instance, the inquiry 302 (“What subject would you like help with today?”) is followed by a series of numbers corresponding to, for example, (1) math; (2) chemistry; (3) English; (4) psychology; and (5) biology. Alternatively, the questions may be configured to solicit an answer which may be quantified, e.g., numerically. In that case, the tutee may be prompted to provide an answer somewhere along a scale based on their preference for the activity. For instance, a “1” can indicate that the user enjoys baseball while a “5” indicates that the user does not enjoy baseball. Because the answer to each question varies from user to user, each inquiry and the associated answers are referred to as variables.

Surveys 300 can be completed for the purpose of generating enough data for the matching service to make reliable matches. For instance, a large number of students can be enlisted to fill out the surveys 300. These answers can then be used to construct an empirical database that can be used in the method of matching tutees with compatible tutors.

In an embodiment, a survey 300 can be completed by means of a remote computer 116 with access to the matching service 114. The survey can be made available to the user in the form of one or more web pages after the user has registered for use of the matching service. After submitting the completed survey to the matching service, the tutee can request a list of tutor candidates from the matching service.

The survey and/or the registration process can also request that the tutee submit a profile. The profile information may be provided to a candidate tutor to assist the tutor in determining whether they would like to be paired with the tutee. The information which is provided can be entirely up to the user although the matching service can make suggestions about information which has been successful at eliciting responses. The preliminary information can include the tutee's level of academic achievement (e.g., grade point average), learning strengths and weaknesses, and outside interests (e.g., sports, music, hobbies), to thereby increase the likelihood of a compatible pairing.

The survey 300 may be revised from time to time. For instance, as the matching service 114 determines that certain inquiries are less effective at revealing the effectiveness of pairings, inquiries can be removed from the survey. Additionally, the matching service can add new questions to the survey to enhance the predictive value of the survey.

As described above, the answers to the survey 300 are used to generate an empirical database. FIG. 4 is an example of an empirical database 400. The empirical database 400 includes a column of identifier field 402 that which identifies the person who filled out the survey 300. Example identifiers include a person's name or other identifier (e.g., user name, avatar, pseudo-name) associated with a particular person. The empirical database 400 also includes a plurality of variable columns A, B, . . . N. Each variable column corresponds to one of the inquiries 302-310 discussed above in connection with FIG. 3. Each field in a variable column indicates a particular person's answer to a survey inquiry. Fields in the empirical database 400 can also be empty, either because an inquiry was dropped or because a user did not answer an inquiry.

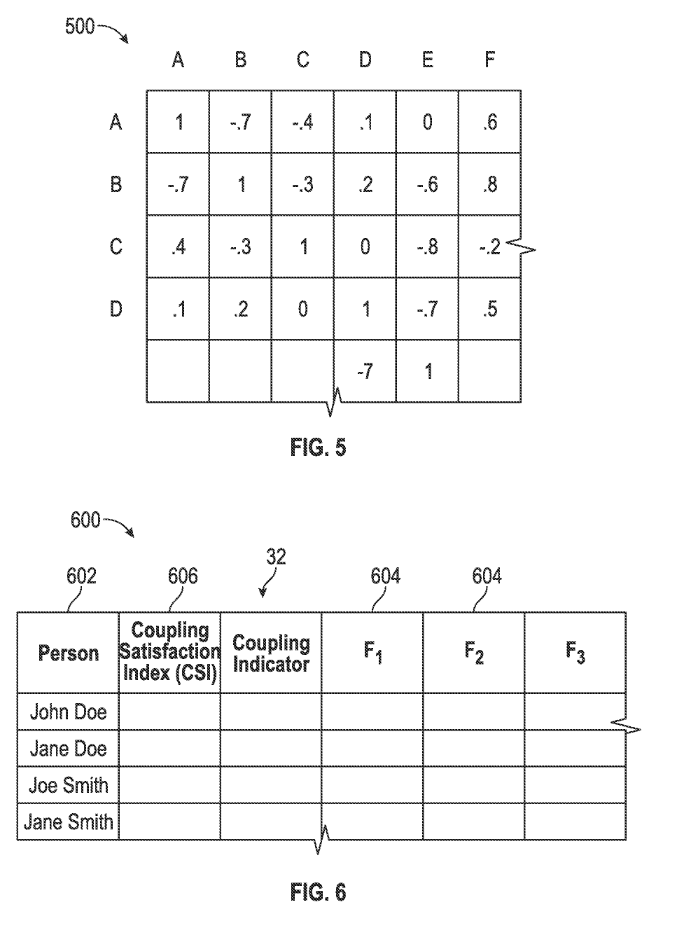

Referring now to FIG. 5, a correlation matrix 500 is constructed from the empirical database 400 in order to illustrate the degree of correlation between the variables of the empirical database 400. Each field of the correlation matrix 500 shows the degree of correlation between two of the variables. The degree of correlation can vary from negative one to positive one. A value of one indicates a high degree of correlation between the two variables. As a result, the correlation between variable A and itself is 1. The correlation matrix 500 may be constructed using the data embodied in the empirical database 400. A suitable program for generating the correlation matrix is STATISTICA™ available from Statsoft, Inc. of Tulsa Okla. The variables used to construct the correlation matrix 500 may be selected from the variables in the empirical database 400 by the matching service 114. As a result, variables that are less relevant to predicting a satisfactory pairing can be removed from the correlation matrix, as desired.

The correlation matrix 50o is examined to identify combinations of correlated variables that are commonly called factors. The factors are identified in a statistical process known as factor analysis. Factor analysis is one method of combining multiple variables into a single factor in order to reduce the total number of variables that must be considered. Hence, each factor may be determined as a function of one or more variables. For example, the factors can be a weighted linear combination of two or more variables. The factor analysis is preferably performed to identify the minimum number of factors needed to account for the maximum percentage of the total variance present in the original set of variables. A suitable factor analysis includes, but is not limited to, a principle component analysis with an eigenvalue greater than or equal to 1 criteria and a rotational procedure employing the biquartimax solution.

The factors may then be used to generate a factor value database 600, for example, as illustrated in FIG. 6. The factor value database 600 can include a column of identifier fields 602 and several columns of factor fields 604. Each field in a column of factor fields 604 lists the value of a factor for a particular student. The students listed in the factor value database can include different students than the empirical database. For instance, as data in the empirical database becomes outdated it can be dropped from the factor value database.

The factor value database 600 also includes a column of individual satisfaction index fields 606. The individual satisfaction index may indicate the level of satisfaction that a particular tutee has had with a previous tutor. A suitable individual satisfaction index is the Dyadic Adjustment Scale (DAS). The DAS is a tool for assessing the level of satisfaction a tutee experienced with a previous tutor or other interpersonal, non-tutoring relationship (e.g., student/teacher, student/parent). The DAS for a particular tutee can be generated from answers to survey inquiries discussed above. Because the DAS can be determined for prior interpersonal experiences, the DAS is a useful individual satisfaction index for developing the data needed by the matching service 114 prior to the time the matching service has enough users to generate statistics concerning the quality of pairings made by the matching service. Other individual satisfaction indices can be generated for use with the present invention.

The factor value database 600 may be used to approximate relationships between the individual satisfaction index and one or more of the factors. This relationship is called an individual satisfaction estimator because the relationship can be used to approximate an individual satisfaction index for an individual as will be described in more detail below.

An individual satisfaction estimator can be determined for each “match group” of candidate tutors. A match group is a group of prospective (or candidate) tutors who may have different factors influence their likelihood of a successful pairing relationship. For instance, suitable match groups may include tutors who share one or more of the following attributes with a tutee: the same teacher, the same school and/or school district, classroom, the same academic subject, classroom, schedule (e.g., available Tuesdays and Thursdays at 7:00 p.m.), and/or other relevant factors such as, for example, an affinity for sports, or fluency in a common foreign language. The degree of affinity between a tutee and a particular match group is generated using data for members of the particular match group.

A suitable method for approximating a relationship between the individual satisfaction index and one or more of the factors includes, but is not limited to, performing a multiple linear regression and correlation analysis on the individual satisfaction indexes versus the factor data. Software for performing the multiple linear regression and correlation analysis is available from STATISTICA from Statsoft, Inc. of Tulsa Okla. The linear regression is preferably a step-wise linear regression.

Multiple linear regression and correlation analysis is a preferred method for approximating the relationship because the differential factors that are minimally correlated to the couple satisfaction index can be removed from the relationship. Accordingly, the number of factors included in the relationship are reduced. The factors included in the relationship are called selected satisfaction factors below.

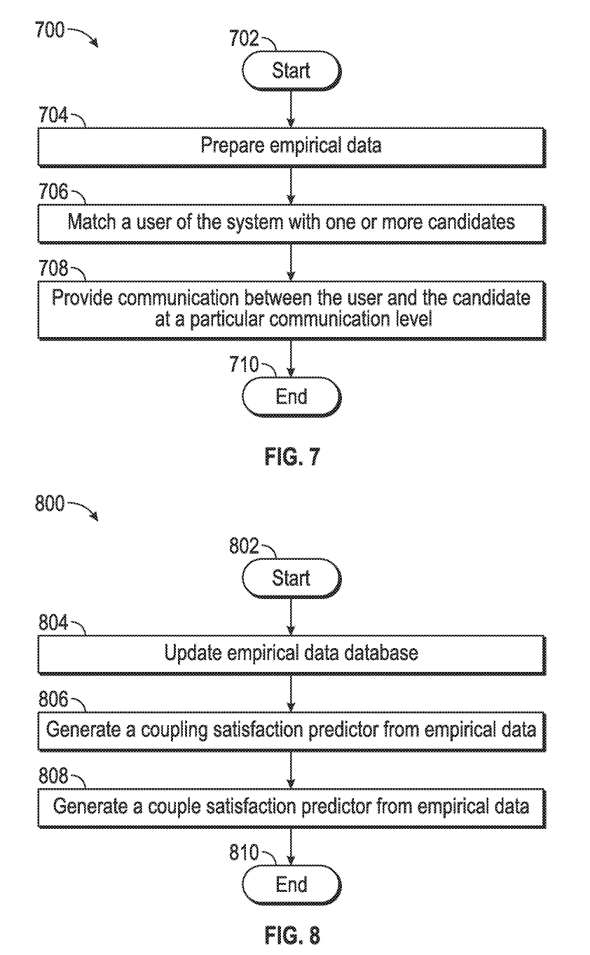

FIG. 7 illustrates an example of generating a relationship between the individual satisfaction index and one of the factors. For the purposes of illustration, the example is highly simplified to include a single factor. The individual satisfaction indexes for tutees are plotted versus the value of a factor labeled F1. The results of a step-wise linear regression performed on the plotted data is illustrated. These results are the approximated relationship between the individual satisfaction index and the factor value.

The matching system 114 matches a tutee with one or more candidate tutors. The user (tutee) fills out a survey, for example, while logged onto the tutoring portal (website) using the remote unit 116. In one embodiment, the survey 20 includes only the variables needed to calculate each of the selected factors and the selected differential factors. In another embodiment, the survey includes the variables needed to calculate each of the factors identified during the factor analysis. In yet another embodiment, the survey includes more variables than are needed to calculate the factors identified during the factor analysis.

The matching service 114 receives the survey filled out by the user and the user's match group is identified. The individual satisfaction estimator associated with the identified match group is identified. The user's answers to the inquiries are compared to the identified individual satisfaction estimator to determine an approximate individual satisfaction index for the user.

The matching service 114 then selects candidate tutors to be matched with the tutee. The selected candidates fall within either the same or similar class as the tutee. The matching service identifies a pairing satisfaction estimator associated with the tutee's classification, and the tutee is prompted to select one of the identified candidates. The tutee's answers to the inquiries and the selected candidate's answers to the questions are compared to the identified pairing satisfaction estimator to determine an approximate satisfaction index for the tutee and the selected tutor. As discussed above, the approximate pairing satisfaction index approximates the satisfaction that the tutee will have in a tutoring relationship with the selected tutor. An approximate pairing satisfaction index is generated for each identified tutor.

The matching service uses the approximate pairing satisfaction index to identify potential matches for the user. For instance, the matching service can select candidates who result in a pairing satisfaction index over a particular threshold as potential matches. Alternatively, some pre-determined number of candidates resulting in the highest pairing satisfaction indexes are identified as potential pairing candidates.

Accordingly, the matching service will have approximated the tutee's satisfaction in a tutoring relationship with a tutor, and the tutor's satisfaction in a tutoring relationship with the tutee.

During the communication stage, the matching service provides preliminary information for the selected tutor (or tutors) to the tutee. The matching service can also provide the tutee with several communication levels from which to choose. Alternatively, the matching service can arrange the communication levels in a particular sequence and require that the tutee and tutor use a particular communication level.

In an embodiment, each of the communication levels allows the parties to exchange information in one or more formats. Examples of exchanging information at different communication levels include exchanging answers to open-ended questions provided by the matching service, exchanging items selected from a list provided by the matching service, exchanging answers to open-ended questions provided by the matching service, and exchanging questions and answers written by the tutee and/or tutor.

The communication levels can be arranged in a preferred communication level sequence. For instance, the communication levels can be sequenced to ensure that a tutee and tutor proceed through the communication levels, thereby facilitating a socially comfortable environment as they exchange increasingly personal information. Once the matching service has settled on a particular sequence, the matching service may require that the tutee tutor progress through the communication levels in sequence. However, the matching service can provide the tutee with the option of choosing when to progress to the next communication level.

One embodiment of the matching service allows the tutee to select communication level at which the tutee and tutor will communicate. As a result, the tutee selects the level he or she is most comfortable communicating and can move forward with the tutoring relationship. Alternatively, a tutee can back off of a tutoring relationship by proceeding to a communication level that allows for a less personal exchange of information. By way of non-limiting example, the following communication modalities are listed in increasing order of personal information: 1) anonymous text, email, and chat; 2) white board which reveals handwriting; 3) audio which reveals voice; and 4) video which reveals the tutee's face.

When the tutee and tutor use the communication service to exchange information they communicate the information to the matching service which then forwards the information to the other party. The matching service can perform this exchange by forwarding an email from one user to another user, or hosting a live session. The matching service can replace each users email address with the user's username before forwarding the e-mail. As a result, the address of the sender can remain confidential and not available to the ultimate recipient. Accordingly, information and/or the identity of the sender may remain confidential when exchanged through the matching service.

The matching service can facilitate an exchange of one or more open-ended questions by providing the tutee and/or the tutor with the same or similar open inquiries. The open-ended questions can be directed toward various issues including, but not limited to, proficiency in a particular academic subject (math, chemistry), thoughts or attitudes toward a particular teacher, assignment, or the like.

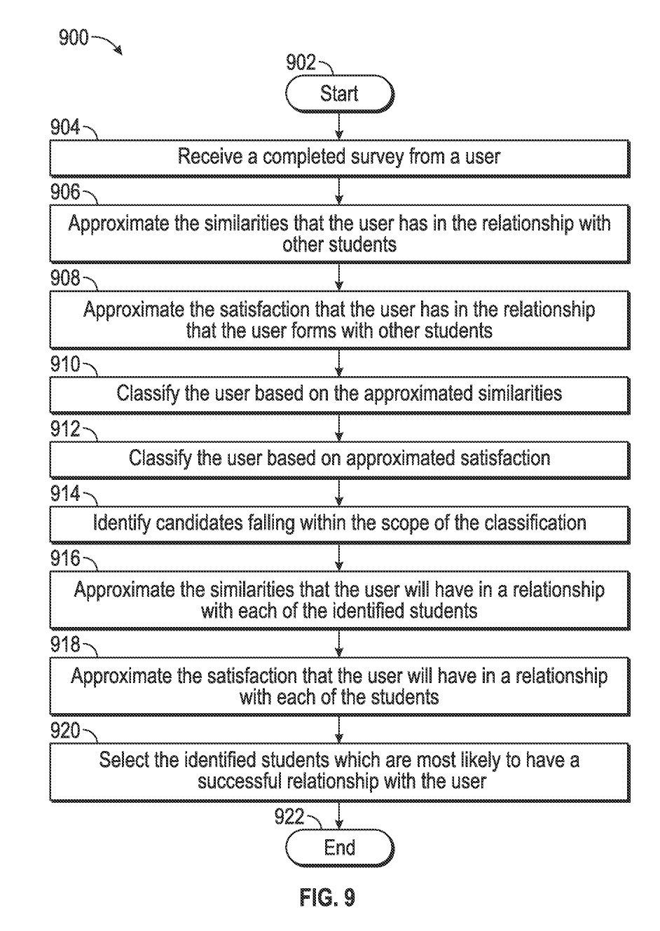

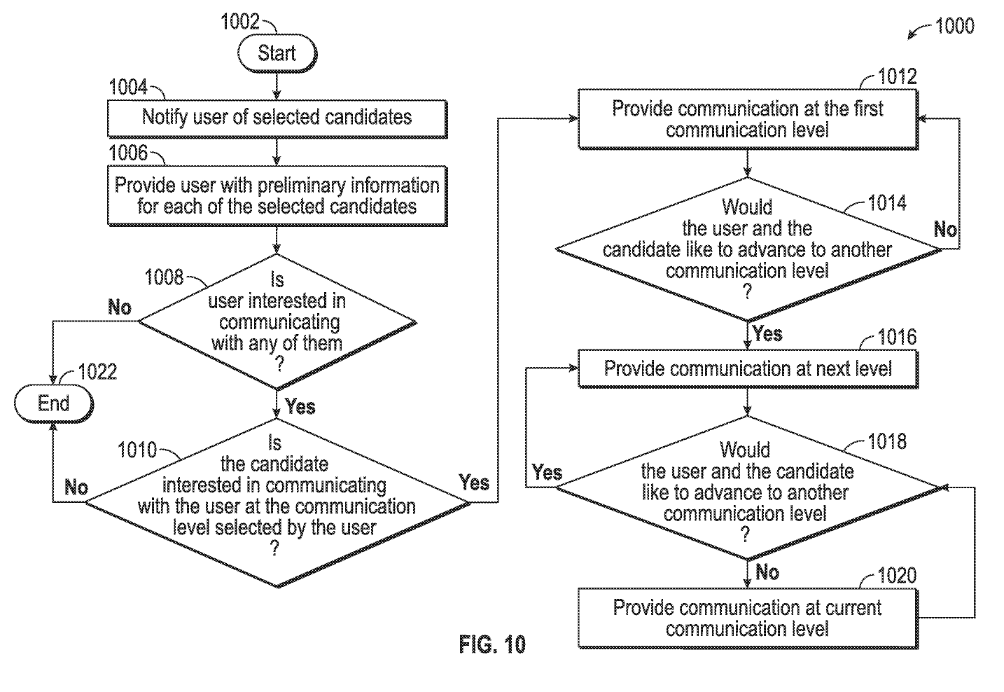

FIG. 7 illustrates an embodiment of a method 700 for operating a matching system. The method begins at start block 702. At process block 702, the matching service prepares empirical data. (An example of a method for preparing the empirical data is illustrated in FIG. 8, described below). At process block 704, the matching service uses the prepared empirical data to match a tutee with one or more tutors selected from a pool of candidates. (An example of a method for matching a tutee with one or more tutors is illustrated in FIG. 9, described below). At process block 706, the matching service provides communication between the tutee and the selected tutor(s). (FIG. 10, described below, provides an example of a method of providing communication between a tutee and the one or more selected tutors). The method 700 terminates at end block 710.

FIG. 8 illustrates an example of a method 800 for preparing empirical data for matching a tutee with a tutor. The empirical data can be prepared before each tutee to be matched with a tutor. Alternatively, the empirical data can be prepared periodically. For instance, the prepared empirical data can be used to match several tutees of the matching service with tutors and then the empirical data can be prepared again.

The method 800 of preparing the empirical data begins at start block 802. The method can be started in response to a tutee accessing the matching service portal, completing a survey, and requesting one or a list of potential tutors. At process block 804 the empirical database is updated. This database can be updated to include information from a completed survey submitted by a tutee who is requesting a list of tutors. Updating the database can also include removal of information from the database. For instance, outdated information can be extracted. Additionally, information can be extracted in order or to convert the database from use of a DAS to an individual satisfaction index which is the result of matches resulting from the matching service. Other databases can be updated at this stage. For instance, data for generating an individual satisfaction index for each tutee/tutor pairing that was matched by the matching service can be incorporated into the databases. The resulting individual satisfaction index can be listed in the factor value database.

At process block 806, the updated empirical database is used to generate an individual satisfaction estimator. At process block 808, the updated empirical database is used to generate a satisfaction estimator for the tutee and tutor as a pair. The method terminates at end block 810.

FIG. 9 illustrates a method 900 of matching a tutee of the system 100 with one or more candidate tutors. The method 900 starts at start block 902, whereupon a tutee completes a survey and requests a list of potentially matching tutors. At process block 904 the completed survey is received from the user.

At process block 906, the system approximates the similarities that the tutee has in relation to potential tutors. At block 908, the system approximates the satisfaction that the tutee has in relationships with other students. This approximation can be made by determining an approximate individual satisfaction index for the tutee. One method for determining the approximate individual satisfaction index includes identifying the match group to which the tutee belongs. The individual satisfaction estimator associated with the identified match group is then identified. The user's answers to at least a portion of the inquiries on the survey are compared to the identified individual satisfaction estimator. In one embodiment, comparing the tutee's answers to the identified individual satisfaction estimator includes calculating the value of the selected factors from the answers that the user provided and then comparing the calculated factors to the individual satisfaction estimator. At process block 910, the tutee is classified based on the approximated similarities. At block 912, the tutee is classified based on the approximate individual satisfaction index.

At process block 914, the tutor candidates that fall within the classification of the tutee are identified. At process block 916, the system approximates the similarities that the tutee would have in relation to the candidate tutors. At process block 918, the system approximates the satisfaction that the tutee would have with each of the identified tutors. This approximation can made by determining an approximate couple satisfaction index for the tutee and a tutor. One method for determining the approximate couple satisfaction index includes comparing at least a portion of the answers provided by the tutee and the tutors to the couple satisfaction estimator. In one embodiment, comparing the answers provided by the tutee and a tutor to the couple satisfaction estimator includes calculating the selected differential factors from the answers provided by the tutee and tutor and comparing the selected differential factors to the couple satisfaction estimator.

At process block 920, the approximated levels of satisfaction that the tutee would have in a tutoring relationship with each of the identified tutor candidates are used to select the candidates for a potential match with the tutee. As described above, selecting the candidates can also include approximating the satisfaction that each candidate would have in a tutoring relationship with the tutee. The method then terminates at end block 922.

FIG. 10 illustrates a method 1000 of providing communication between the tutee and a tutor. As described above, one embodiment of the invention includes allowing the tutee and a candidate or selected (confirmed) tutor to select the communication level on which they will communicate while another embodiment of the invention requires the tutee and tutor to progress through a sequence of communication levels. FIG. 10 illustrates an exemplary method 1000 for providing communication between the tutee and a tutor when the matching service requires them to proceed through a sequence of communication levels.

The method 10000 starts at start block 1002. The tutee is notified of the selected candidate tutors at process block 1004. The preliminary information for each of the identified candidates is provided to the tutee at process block 1006. At decision block 1028, a determination is made whether the tutee wishes to communicate with any of the identified candidates. When the determination is positive (“Yes” or “Y” branch from block 1008), a decision block 1010 is accessed. At decision block 1010, a determination is made whether the tutor is interested in tutoring the tutee. This determination can be made by providing the candidate tutor with the tutee's preliminary information. The candidate can respond to the matching service 114 by indicating whether he/she would like to communicate with the user.

When it is determined that the tutor would like to communicate with the tutee at determination block 1010, process block 1012 is accessed. At process block 1012, communication is provided between the tutee and the tutor at the first communication level of the sequence. As described above, providing communication can include forwarding communication from one party to another and/or forwarding questions, lists, data or other information from the matching service to the tutee and/or the tutor.

At determination block 1014, a determination is made whether the tutee and/or the tutor would like to proceed to another communication level. The matching service 114 can make this determination by transmitting a communication to one or both parties asking whether they would like to try a new communication level. One or both of the parties can be presented with this option after proceeding to a certain point in the current communication level. Alternatively, a communication being forwarded from one party to another can be modified to include the option of indicating a new communication level or the option can simply accompany the communication from one party to the other. When neither party indicates that they would like to communicate at the next communication level, the determination is negative (“No” branch from block 1014) and the method returns to process block 1012.

When one or both parties indicate that they would like to try the next communication level (“Yes” branch from block 1014), the determination at decision block 1014 is positive and the method proceeds to process block 1016. At process block 1016, communication is provided between the tutee and tutor at the next communication level of the sequence. At determination block 1018 a determination is made whether the tutee (and/or the tutor) would like to proceed to another communication level. When the determination is positive (“Yes” or “Y” branch from block 1018), the method returns to process block 1016 and the parties may proceed to the next communication level. When the determination is negative (“No” or “N” branch from block 1018), the method 1000 proceeds to process block 1020 whereupon the tutee and tutor continue to communicate at the current communication level.

When the determination at determination block 1008 or determination block 1010 are negative, the method terminates at end block 1022. Additionally, either party can indicate to the matching service 114 that they wish to terminate the communication at any time. When a party indicates that they wish to terminate the communication, the method may be configured to end at end block 1022.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

A method implemented by a computer system is thus provided for pairing a first student seeking academic assistance with a second student qualified to provide the assistance. The method includes: receiving, from the first student, a first survey including information pertaining to the subject matter for which tutoring is sought, the grade level, school name, teacher name, and a first schedule of availability; receiving, from a second student, a second survey including information pertaining to the subject matter in which the second student is proficient and a second schedule of availability; comparing the first and second surveys to determine a match; and facilitating an initial communication level between the first student and the second student while preserving the anonymity of the first student.

In an embodiment, the first survey includes a plurality of open ended questions and/or a plurality of closed ended questions; wherein each of the plurality of closed ended questions may be configured to prompt the first student to select one of a plurality of predefined answers.

In an embodiment, the first and second surveys are received via an on-line web portal.

In an embodiment, the initial communication comprises textual messaging.

In an embodiment, the computer system is further configured to facilitate subsequent communication level between the first student and the second student which includes at least one of an audio component and a video component.

In an embodiment, the first student determines when the communication proceeds from the initial level to the second level.

In an embodiment, comparing comprises: generating, from the first and second surveys, a number of factors corresponding to a like number of functions of variables relevant to a satisfactory tutoring relationship; approximating the satisfaction that the first student has experienced in relationships with other students; identifying the second student as a candidate tutor by determining an association between the approximated satisfaction and at least one of the factors; and approximating the satisfaction that the first student will have in a tutoring relationship with the second student.

In an embodiment, approximating the satisfaction includes generating an approximate individual satisfaction index for the first student.

In an embodiment, approximating the satisfaction includes generating an individual satisfaction estimator.

In an embodiment, comparing comprises evaluating answers provided by the first student against an individual satisfaction estimator.

In an embodiment, comparing further comprises: classifying the first student into a first class based on the approximated satisfaction; and determining that the second student falls within the first class.

In an embodiment, determining a match includes generating a pairing satisfaction estimator.

In an embodiment, the pairing satisfaction estimator includes a relationship between an individual satisfaction index and at least one question answered by the first student.

A method, to be performed by a computer, is provided for operating a peer-to-peer tutor matching service. The method includes: receiving a plurality of surveys completed by a plurality of students, respectively, each survey including a plurality of inquiries into matters relevant to each student performing in a tutoring relationship, at least a portion of the inquiries having answers that are associated with a number; performing a factor analysis on the answers to the inquiries to identify a plurality of factors, each factor corresponding to a function of at least one or more variable representing the inquiries; generating a satisfaction index that approximates the satisfaction that a tutee candidate has in the relationships that the tutee candidate forms with others; and matching the tutee candidate to a tutor candidate based upon the satisfaction index and based upon differences between the value of at least one factor for the tutee candidate and the value of at least one factor for the tutor candidate.

In an embodiment, the factor analysis is a principal component analysis, and the method further includes selecting the factors that most highly predict satisfaction in a tutoring relationship; wherein selecting the factors includes performing a linear regression on the factors and the satisfaction index.

In an embodiment, selecting the factors includes performing a correlation analysis on the factors and the satisfaction index.

An automated system for facilitating on-line peer-to-peer tutoring is also provided. The system may be configured to: generate, from empirical data, a number of factors corresponding to a like number of functions of one or more variables relevant to approximating the level of satisfaction in a tutoring relationship; approximate the satisfaction that a tutee seeking tutoring has experienced in peer relationships; identify candidate tutors by determining an association between the approximated satisfaction and one or more of the factors; and approximate the satisfaction that the tutee is likely to have in a tutoring relationship with a particular candidate tutor.

In an embodiment, the system is further configured to facilitate communication between the tutee and the particular candidate tutor while selectively concealing the identity of the tutee from the candidate tutor.

What is claimed:

1. A method performed by a computer system for pairing a first student seeking academic assistance with a second student qualified to provide the assistance, comprising:
receiving, from the first student, a first survey including information pertaining to the subject matter for which tutoring is sought, the grade level, school name, teacher name, and a first schedule of availability;
receiving, from a second student, a second survey including information pertaining to the subject matter in which the second student is proficient and a second schedule of availability;
comparing the first and second surveys to determine a match; and
facilitating an initial communication level between the first student and the second student while preserving the anonymity of the first student.

2. The method of claim 1, wherein the first survey includes a plurality of open ended questions.

3. The method of claim 1, wherein the first survey includes a plurality of closed ended questions.

4. The method of claim 3, wherein each of the plurality of closed ended questions are configured to prompt the first student to select one of a plurality of predefined answers.

5. The method of claim 1, wherein the first and second surveys are received via an on-line web portal.

6. The method of claim 1, wherein the initial communication comprises textual messaging.

7. The method of claim 1, wherein the computer system is further configured to facilitate subsequent communication level between the first student and the second student which includes at least one of an audio component and a video component.

8. The method of claim 7, wherein the first student determines when the communication proceeds from the initial level to the second level.

9. The method of claim 1, wherein comparing comprises:
generating, from the first and second surveys, a number of factors corresponding to a like number of functions of variables relevant to a satisfactory tutoring relationship;
approximating the satisfaction that the first student has experienced in relationships with other students;
identifying the second student as a candidate tutor by determining an association between the approximated satisfaction and at least one of the factors; and
approximating the satisfaction that the first student will have in a tutoring relationship with the second student.

10. The method of claim 9, wherein approximating the satisfaction includes generating an approximate individual satisfaction index for the first student.

11. The method of claim 9, wherein approximating the satisfaction includes generating an individual satisfaction estimator.

12. The method of claim 11, wherein comparing comprises evaluating answers provided by the first student against an individual satisfaction estimator.

13. The method of claim 12, wherein comparing further comprises:
classifying the first student into a first class based on the approximated satisfaction; and
determining that the second student falls within the first class.

14. The method of claim 12, wherein determining a match includes generating a pairing satisfaction estimator.

15. The method of claim 8, wherein the pairing satisfaction estimator includes a relationship between an individual satisfaction index and at least one question answered by the first student.

16. A method to be performed by a computer for operating a peer-to-peer tutor matching service, comprising:
receiving a plurality of surveys completed by a plurality of students, respectively, each survey including a plurality of inquiries into matters relevant to each student performing in a tutoring relationship, at least a portion of the inquiries having answers that are associated with a number;
performing a factor analysis on the answers to the inquiries to identify a plurality of factors, each factor corresponding to a function of at least one or more variable representing the inquiries;
generating a satisfaction index that approximates the satisfaction that a tutee candidate has in the relationships that the tutee candidate forms with others; and
matching the tutee candidate to a tutor candidate based upon the satisfaction index and based upon differences between the value of at least one factor for the tutee candidate and the value of at least one factor for the tutor candidate.

17. The method of claim 16, wherein the factor analysis is a principal component analysis, the method further comprising:
selecting the factors that most highly predict satisfaction in a tutoring relationship;
wherein selecting the factors includes performing a linear regression on the factors and the satisfaction index.

18. The method of claim 16, wherein selecting the factors includes performing a correlation analysis on the factors and the satisfaction index.

19. An automated system for facilitating on-line peer-to-peer tutoring, configured to:
generate, from empirical data, a number of factors corresponding to a like number of functions of one or more variables relevant to approximating the level of satisfaction in a tutoring relationship;
approximate the satisfaction that a tutee seeking tutoring has experienced in peer relationships;
identify candidate tutors by determining an association between the approximated satisfaction and one or more of the factors; and
approximate the satisfaction that the tutee is likely to have in a tutoring relationship with a particular candidate tutor.

20. The system of claim 19, further configured to facilitate communication between the tutee and the particular candidate tutor while selectively concealing the identity of the tutee from the candidate tutor.
